(19) United States
(12) Patent Application Publication
(10) Pub. No.: US 2005/0236165 A1
(43) Pub. Date: Oct. 27, 2005

(54) Horseshoe with shock absorbing properties

(75) Inventors: Ronald George Yates, Burwood, Victoria (AU); Gerard Osborne Suttie, South Oakleigh (AU)

Correspondence Address: KIRK HAHN, 14431 HOLT AVE, SANTA ANA, CA, 92705, US

(73) Assignee: Gliderz Corporation Pty Ltd, Knoxfield, Victoria (AU)

(21) Appl. No.: 10/527,876

(22) PCT Filed: Sep. 16, 2003
(86) PCT No.: PCT/AU03/01214

§ 371 Date: Mar. 16, 2005

(30) Foreign Application Priority Data
Sep. 16, 2002 (AU) 2002951396

(51) Int. Cl. A01L 5/00; A01L 1/04

(52) U.S. Cl. 168/4

(57) ABSTRACT

A horseshoe (110) comprising a core (30) of rigid material sandwiched between two layers (40, 50) of shock absorbing elastomeric material. At least one of the elastomeric layers (40, 50) is bonded to the core (30) at a face (31, 33) where the core (30) has a plurality of indentations (32) or a plurality of raised humps (34). A preferred shoe (110) has raised lips (160, 164) and ridges (170) formed in its lower face (146).

### BACKGROUND OF THE INVENTION

This invention concerns the incorporation of shock absorbing characteristics into the structure of a horseshoe. It has particular applicability for racehorses which, although bred for speed and endurance, often suffer from leg problems due to the very high stresses placed on the legs due to high impact loads while racing and especially during the heavy training required in preparation for racing.

Attempts have been made previously to incorporate layers of elastic, shock absorbing materials, such as silicone rubber, into horseshoes but none have been successful in the marketplace. This has been at least in part due to one or more of:
poor lifespan due to a high wear rate of the shock absorbing material,
failure of the bond between the main structural material and the shock absorbing material,
in order to provide sufficient shock absorption, the rubber needed to be so thick that the weight of the shoe became too heavy.

An aim of the present invention is to provide a horseshoe which at least reduces these difficulties.

### SUMMARY OF THE INVENTION

Accordingly, in one aspect the invention provides a horseshoe comprising a core of rigid material sandwiched between a first layer of shock absorbing elastomeric material and a second layer of shock absorbing elastomeric material, at least one of said first and second layers being bonded to the core of rigid material at a face where the rigid material has a plurality of indentations or a plurality of raised humps.

Preferably one of said first and second layers is bonded to the rigid material at a face where the rigid material has a plurality of dished depressions and the other of said first and second layers is bonded to the rigid material at a face where the rigid material has a plurality of raised humps.

Preferably the indentations are dished depressions. Preferably the dished depressions are circular. Preferably the humps are circular. The elastomeric material in the first layer may be a different thickness and/or have a different composition to the elastomeric material in the second layer.

An insert may be anchored into said layer of rigid material and protrude into one of said first and second layers to provide a wear resistant strip.

The core of the horseshoe may comprise:
an upper face adapted to face the hoof of a horse,
a lower face adapted to face the ground,
a curved inner wall extending between the upper face and the lower face,
a curved outer wall between the upper face and the lower face,
said inner wall and outer wall blending at heel portions of the shoe, and
said lower face having:
   a raised rim adjacent said inner wall,
   a raised rim adjacent said outer wall, and
   a plurality of ridges linking said rims,
      such that said rims and ridges in combination form depressions therebetween which are at least substantially filled with elastomeric material.

The horseshoe may have:
an upper face adapted to in use be affixed in contact with a horse's hoof,
a bottom face, forming a sole face of the shoe, said sole face being intended to in use bear on the ground,
a curved inner wall extending between the upper face and the sole face,
a curved outer wall between the upper face and the sole face,
said inner wall and outer wall blending at heel portions of the shoe, and
said sole face having:
   a raised rim adjacent said inner wall, and
   a raised rim adjacent said outer wall.

The horseshoe may include a toe clip upstanding from the toe of the shoe, wherein said core has integrally formed therewith a toe clip core portion which rises from the toe perpendicular to said layers and wherein the upper portion of said toe clip core projects further forwards from the toe than is the lower portion of the toe clip core.

### BRIEF DESCRIPTION OF THE DRAWINGS

In order that the invention may be more fully understood there will now be described, by way of example only, preferred embodiments and other elements of the invention with reference to the accompanying drawings where:

FIG. 1 is a plan view of the top side of a horseshoe according to a first embodiment of the invention;

FIG. 2 is a cross sectional side view of the horseshoe in FIG. 1 when sectioned along curved line A-A;

FIG. 3 is a cross sectional front view of the horseshoe in FIG. 1 when sectioned along curved line B-B;

FIG. 4 is a plan view of the internal frame (core) of the horseshoe in FIG. 1;

FIG. 5 is a perspective view of the underside of a horseshoe according to a second embodiment of the invention, looking from the heel;

FIG. 6 is a perspective view of the top side of the horseshoe in FIG. 5 looking from the heel;

FIG. 7 is a plan view of the underside of the horseshoe in FIG. 5;

FIG. 8 is a side view of the horseshoe shown in FIG. 5,

FIG. 9 is a perspective view of the underside of the internal frame (core) of the horseshoe in FIG. 5;

FIG. 10 is a perspective view of the top side of the core in FIG. 9;

FIG. 11 is a plan view of the core in FIG. 9 looking from the underside;

FIG. 12 is a side view of the core in FIG. 9; and

FIG. 13 is a view from the rear of the core shown in FIG. 9.

### DESCRIPTION OF EXAMPLES OF THE INVENTION AND THE PREFERRED EMBODIMENT

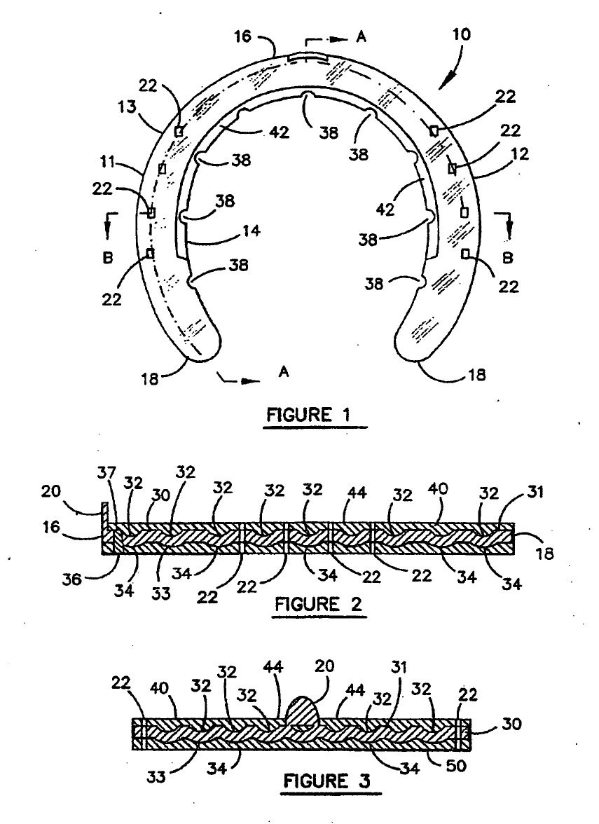

Referring to FIGS. 1 to 4, the horseshoe 10 illustrated has a generally conventional overall horseshoe shape. From a toe 16 the shoe extends by way of two side arms 11 and 12 to a pair of heels 18. The shoe 10 has an outer wall 13, an inner wall 14, a raised toe clip 20 and nail holes 22.

As best seen in FIGS. 2 and 3, the shoe 10 has a composite structure with three layers. The middle layer provides a core (or frame) 30 for attachment of the other two layers 40 and 50. The core 30 is made of any of the aluminium alloys commonly used for horseshoes. It provides most of the strength and shape retention for the shoe. The core 30 is manufactured by pressing a preform from a 4 mm thick aluminium sheet, with the toe clip 20 extending out from the toe 16, then bending the toe clip up into position, and finally heat treating the core to harden it.

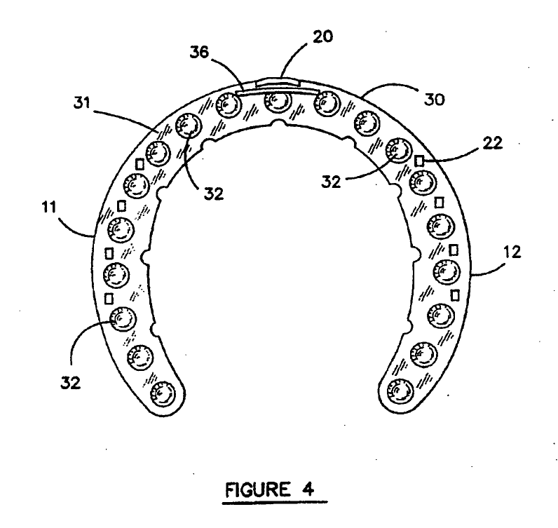

The upper layer 40 is a polyurethane mat approximately 2 mm thick which is tightly bonded to the top face 31 of the core 30 and provides a shock absorbing bed for a horse's hoof to which it would be attached. The lower layer 50 is a polyurethane mat approximately 4 mm thick which is tightly bonded to the bottom face 34 of the frame 30 and provides a high friction, wear resistant sole. It should be noted that FIG. 4 shows the metal core 30 with no polyurethane attached. Layers 40 and 50 may be preformed before being adhered to the core 30, but it is preferred for the layers 40 and 50 to be injection moulded directly onto the core 30.

The shock absorbing elastomeric materials used in layers 40 and 50 may be any suitable materials but are preferably selected from the range of polyurethanes widely supplied and known by the skilled person. They are preferably a thermoplastic urethane suitable for injection moulding applications and sold under the name Teton 90 by Urethane Compounds Pty Ltd in Australia. Use of a Chemloc (trade mark) primer from Lord Chemicals is also preferred in order to increase the bond between the polyurethane and the metal core.

The upper face 31 of the core 30 incorporates an array of indentations 32. These take the form of relatively gently dished depressions or concavities aligned in an arc across the toe 16 and down the side arms 11 and 12. Each indentation 32 is centred on the centreline of the face 31. The indentations 32 are circular with a diameter about half the width of face 31. Their diameter may be between 25% and 75% of the width of face 31. The depth of the depressions is 2 mm, which is approximately a quarter of their diameter, but this could be varied to between 10% and 70%, preferably between 20% and 50%. Although the indentations 32 could be steeply walled, a shallow wall angle is preferred.

The lower face 33 of the core 30 incorporates an array of protrusions 34. These take the form of relatively gently raised mounds or humps aligned in an arc across the toe 16 and down the side arms 11 and 12. Each protrusion is centred on the centreline of the face 33. The protrusions 34 are circular with a diameter about half the width of face 33. Their diameter may be between 25% and 75% of the width of face 33. The height of the protrusions is 2 mm, which is approximately a quarter of their diameter, but this could be varied to between 10% and 70%, preferably between 20% and 50%. Although the protrusions 34 could be steeply walled, a shallow wall angle is preferred.

The indentations 32 and protrusions 34 are formed by press-forming the metal of the core 30 such that each protrusion is formed directly through the metal from the action of forming a corresponding indentation. The indentations are depressed and the protrusions raised by approximately 50% of the thickness of the metal.

The indentations and protrusions provide the potential for improved adhesion between the shock absorbing materials and the core material. However it is thought that the indentations and protrusions provide a more important advantage in that their presence appears in some way to significantly increase the shock absorption characteristics of the layers 40 and 50 when compared to layers of the same thickness when applied to flat surfaces. A full explanation for this improved performance is not known at this time and we do not wish to be limited by some theory which may or may not correctly explain the advantages observed.

In the toe 16 of the shoe, just behind the toe clip 20, a wear strip is incorporated. The wear strip is formed by a steel insert 36 held in a slot 37 which passes through the core 30. The insert 36 extends to the outer surface of the sole layer 50 and provides resistance to premature wear of the sole layer 50 at the toe 16 while still allowing most of the horseshoe's contact with the ground to be made by the shock absorbing material in the sole layer 50. Both the insert 36 and the slot 37 are curved when viewed from above as in FIG. 4, although the insert may be manufactured flat and curved to suit the slot only when it is being inserted into the slot. As can be seen in FIG. 2, the thickness of both the insert 36 and slot 37 have a gentle taper, narrowing from the bottom to the top. This facilitates entry of the insert into the slot and also prevents the insert pressing further up through the slot when it is impacted from below during use. The insert 36 may be welded, glued or otherwise affixed into the slot 37, or it may be retained only by frictional wedging within the slot 37 and/or adherence to the sole layer 50.

The inner wall 14 of the core 30 carries a series of cutouts 38 which provide a region of weakness for plastic deformation of the core to allow a farrier to bend the shoe to fit it to the particular shape of a given horse's hoof.

As seen in FIG. 4, a stepped recess 42 is let into the upper surface 44 of the upper layer 40. The step 42 is approximately 1 mm deep and extends approximately 25% of the total width across the face 44. The step 42 allows greater air flow to the horse's hoof while the shoe is fitted and allows greater freedom of movement of the adjacent soft portions of the hoof.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

For example, while the core 30 of the preferred embodiment is aluminium, it may instead be formed from any suitable rigid material such as for example steel, magnesium, titanium or a fibre reinforced composite plastics material. While punching and press forming operations are used to form the core 30 in the preferred embodiment, alternatives could be used such as die casting or injection moulding.

Also, whereas the indentations 32 and protrusions 34 of the preferred embodiment are circular and gently dished or humped with a depth and height respectively about a quarter of their diameter, the invention also envisages the indentations and protrusions being of alternative shapes. Also, instead of a toe clip 20, a horseshoe of the invention may utilise quarter clips, which rise from the outer wall 13 of the side arms 11 and 12, to restrict sliding of the hoof on the shoe.

In a particularly preferred embodiment of the invention, the layers 40 and 50 are applied to the core 30 at the same time in an injection moulding operation and the polyurethane applied is also caused to cover the outer wall 13, inner wall 14 and the toe clip 20. A particular advantage from providing the polyurethane covering on the outer wall 13 is that if a horse strikes its hoof against another leg, either its own or another horse's in a race, there is significantly less damage done to the leg receiving the blow.

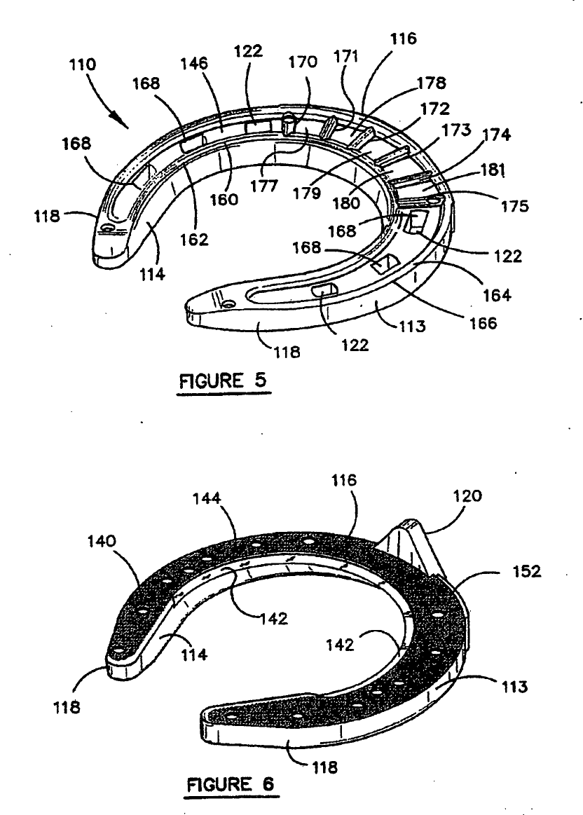

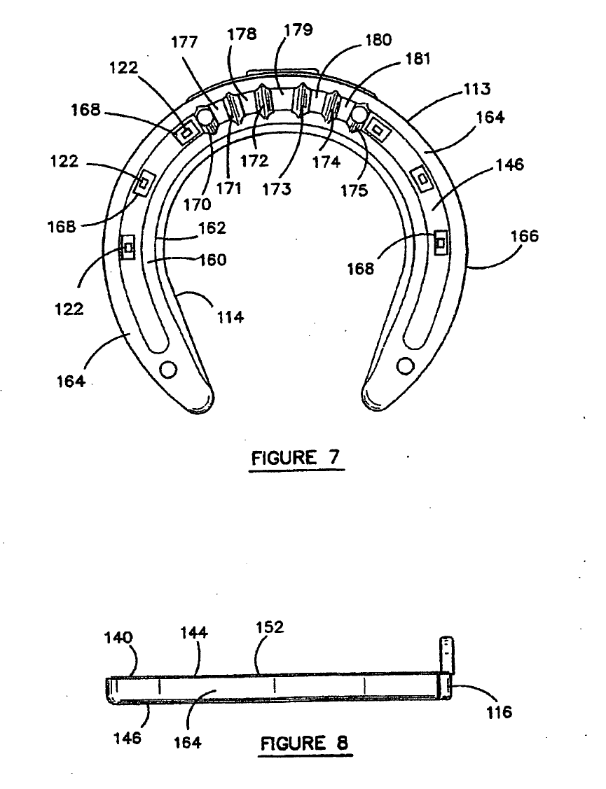

Referring now to the embodiment shown in FIGS. 5 to 8, the horseshoe 110 has a toe portion 116, two side arms 111 and 112, and a pair of heels 118. The shoe 110 has an outer wall 113, an inner wall 114, a raised toe clip 120 and nail holes 122. It has an upper face 144, which in use would be in contact with a horse's hoof, and a lower face 146 which in use would contact the ground.

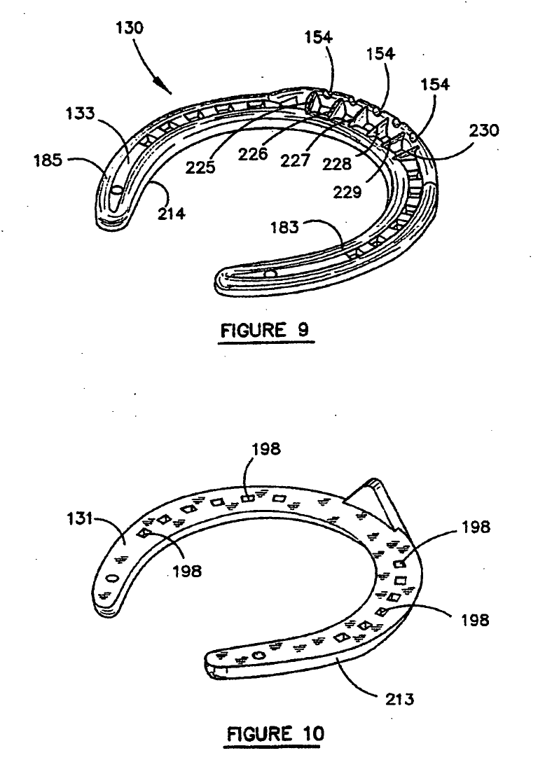

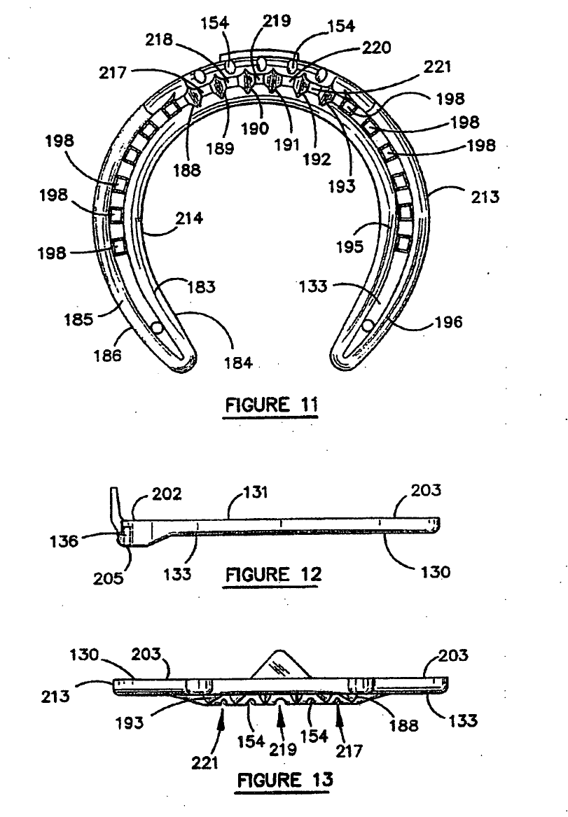

The shoe 110 has a composite structure with three layers. The middle layer provides a frame or core 130 for attachment of the other two layers 140 and 150 and is described in more detail later in this specification with reference to FIGS. 9 to 13.

Although only six nail holes 122 are shown in the shoe 110, more may be provided if desired. Preferably about 12 holes would be provided and their positioning can be determined by reference in particular to FIG. 10 and its accompanying description later in this specification.

The upper layer 140 is a polyurethane coating approximately 2 mm thick and the lower layer 150 is approximately 4 mm thick. Both layers 140 and 150 are injection moulded at the same time in a common die directly onto the core 130. During the same moulding process a polyurethane coating is moulded onto the curved peripheral vertical faces which form the outer wall 113 and the inner wall 114 of the shoe.

The horseshoe has a downwardly facing main face or under-surface 146 into which is moulded a series of raised rims, lips, ribs and depressions. The under-surface 146 is that surface which in use bears on the ground and, for convenience, the under-surface 146 may be referred to herein as the sole face because it forms the outer face of the sole of the shoe. The shoe has, on the obverse side to the under-surface 146, an upper surface 144 which in use is held in contact with a hoof of a horse. The shoe is nailed to the hoof in the normal manner.

A raised rim 160 (hereinafter called the inner rim) is formed on the sole face 146 immediately adjacent to the inner wall 114. The radially inner wall 162 of the inner rim 160 blends smoothly into the vertical face of wall 114. Similarly a raised rim 164 (hereafter called the outer rim) is formed on the sole face 146 immediately adjacent to the outer wall 113 and the radially outer wall 164 of the inner rim 160 blends smoothly into the vertical face of wall 113.

Around the toe area of the sole face 146, six ridges 170 to 175 run across the face of the shoe to link the inner rim 160 and the outer rim 164 and form five indentations 177 to 181 therebetween. The ridges 170 to 175 are aligned substantially transversely to the rims 160 and 162 where they meet. The ridges 170 to 175 are straight. While the lips 160 and 164 are curved, there is only a short portion of them forming the wall each indentation 177 to 181, so the indentations are approximately trapezoidal and nearly rectangular in form.

In use the indentations 177 to 181 are particularly useful as they fill up with packed in dirt and this dirt provides a wear resistant plug within the toe region of the horseshoe so that horseshoes having such indentations have been found to wear slower than those lacking the indentations.

The upper surface 144 has formed thereon an array of parallel grooves 152 in the order of 1 mm apart and 1 mm deep. The grooves serve to improve airflow between the hoof and the shoe.

We turn now to the core 130 (also called the frame) illustrated in FIGS. 9 to 13. The lower face 133 of the core incorporates an array of indentations or depressions 134. The lower face 133 of the core 130 has a raised inside rim 183 around its inner wall 214 and a raised outside rim 185 around its outer wall 213. The radially inner wall of the inside rim 183 blends smoothly into the vertical face of wall 214. Similarly a raised rim 185 (hereafter called the outer rim) is formed on the lower face 133 immediately adjacent to the outer wall 213 and the radially outer wall of the rim 185 blends smoothly into the vertical face of wall 213.

Six ridges 188 to 193 link the inside rim 183 to the outside rim 185 and form depressions 134 therebetween which become filled with elastomeric material when the polyurethane coating is put onto the horseshoe. The ridges 188 to 193 are aligned substantially transversely to the rims 183 and 185 where the ridges meet the rims and, like the indentations in the outer layer of the horseshoe, these also have a trapezoidal and approximately rectangular form. Each ridge 188 to 193 extends from about the crest 195 of the inside rim 183 to about the crest 196 of the outside rim 185.

Around the toe portion 202 of the core 130, the outside rim 185 is raised to a greater extent than is the inside rim 183. In other places (eg around the heel portions 203) the outside rim and the inside rim have substantially the same heights throughout. The ridges 188 to 193 accordingly have respective sloped crests 225 to 230, as those crests slope from near the crest of the outside rim down to the crest of the inside rim.

Holes 198 to accommodate nails are provided through the core 130 and corresponding holes are also present in the polyurethane coating 168 to enable placement of nails to affix the shoe to the horse. The shoe 110 shown in FIGS. 5 to 8 utilises only six of the twelve holes 198 provided in the core 130.

Testing indicates the indentations 134 provide a significant increase the shock absorption characteristics of the lower layer 150 when compared to layers of the same thickness when applied to flat surfaces.

Similar to the above described first embodiment, a stepped recess 142 is let into the upper surface 144 of the upper layer 140.

Into the lower face 133 of the core 130, at the front of the toe portion 202, just behind the toe clip 120, a wear strip 205 is incorporated. The wear strip is formed by a strip-shaped steel insert 136 cast edgewise into the core 130. The insert 136 extends to the lower face 133 of the core but not beyond that into the polyurethane.

Directly adjacent the five indentations 217 to 221 the crest 196 of the outside rim has five notches 154 formed therein, one notch corresponding to each indentation. When the polyurethane covering the toe portion of the rim 185 wears down to expose metal, the polyurethane remaining in the notches 154 serve to tie together the polyurethane coating on either side of the crest 196.

The core 130 shown in FIGS. 9 to 13 is made of any suitable aluminium alloy commonly used for horseshoes. The core 130 is manufactured by die casting followed by a heat treatment operation. Many suitable alloys and heat treatment conditions are known to those skilled in making aluminium horseshoes.

In another embodiment of the invention, a shoe with its outer wall 148 covered with polyurethane as described above has incorporated into the polyurethane a luminescent ingredient so that after exposure to light, the shoe will continue to glow for some time. By means of such shoes, the exact motion of a horse's hooves can be recorded by first causing the shoes to glow and then recording images of the horse in subdued light in order to highlight the particular motion of the hooves. Such recorded images may then be more readily interfaced with computer-based moving image analysis techniques in order to diagnose possible problems with the horse's gait.

Whilst the above description includes the preferred embodiments of the invention, it is to be understood that many variations, alterations, modifications and/or additions may be introduced into the constructions and arrangements of parts previously described without departing from the essential features or the spirit or ambit of the invention.

It will be also understood that where the word “comprise”, and variations such as “comprises” and “comprising”, are used in this specification, unless the context requires otherwise such use is intended to imply the inclusion of a stated feature or features but is not to be taken as excluding the presence of other feature or features.

The reference to any prior art in this specification is not, and should not be taken as, an acknowledgment or any form of suggestion that such prior art forms part of the common general knowledge in Australia.

1: A horseshoe comprising a core of rigid material sandwiched between a first layer of shock absorbing elastomeric material and a second layer of shock absorbing elastomeric material, at least one of said first and second layers being bonded to the core at a face where the core has a plurality of indentations or a plurality of raised humps.

2: The horseshoe according to claim 1 wherein the indentations are dished depressions.

3: The horseshoe according to claim 1 wherein one of said first and second layers is bonded to the core at a face where the core has a plurality of dished depressions and the other of said first and second layers is bonded to the core at a face where the core has a plurality of raised humps.

4: The horseshoe according to claim 1 wherein the dished depressions are circular.

5: The horseshoe according to claim 1 wherein the humps are circular.

6: The horseshoe according to claim 1 wherein the elastomeric material in the first layer is a different thickness to the elastomeric material in the second layer.

7: The horseshoe according to claim 1 wherein the elastomeric material in the first layer has a different composition to the elastomeric material in the second layer.

8: The horseshoe according to claim 1 wherein the core of said shoe comprises:
an upper face adapted to face the hoof of a horse,
a lower face adapted to face the ground,
a curved inner wall extending between the upper face and the lower face,
a curved outer wall between the upper face and the lower face,
said inner wall and outer wall blending at heel portions of the shoe, and
said lower face having:
a raised rim adjacent said inner wall,
a raised rim adjacent said outer wall, and
a plurality of ridges linking said rims,
such that said rims and ridges in combination form depressions therebetween which are at least substantially filled with elastomeric material.

9: The horseshoe according to claim 8 wherein said rim adjacent the inner wall and said rim adjacent the outer wall are joined at the heels of said lower face by continuations of the rims which sweep around the heels on the lower face.

10: The horseshoe according to claim 8 wherein said ridges are aligned substantially transverse to said rims where the ridges meet the rims.

11: The horseshoe according to claim 10 wherein each said ridge extends from about the crest of said inner rim to about the crest of said outer rim.

12: The horseshoe according to claim 8 wherein said depressions have an approximately rectangular or trapezoidal appearance from the lower face.

13: The horseshoe according to claim 8 wherein said core has, around its toe portion, said outer rim raised to a greater extent than said inner rim.

14: The horseshoe according to claim 13 wherein the crests of said ridges are sloped from the inner rim to the outer rim.

15: The horseshoe according to claim 1 and including a toe clip upstanding from the toe of the shoe, wherein said core has integrally formed therewith a toe clip core portion which rises from the toe perpendicular to said layers and wherein the upper portion of said toe clip core projects further forwards from the toe than is the lower portion of the toe clip core.

16: The horseshoe according to claim 1 said shoe having:
an upper face adapted to in use be affixed in contact with a horse's hoof,
a bottom face, forming a sole face of the shoe, said sole face being intended to in use bear on the ground,
a curved inner wall extending between the upper face and the sole face,
a curved outer wall between the upper face and the sole face,
said inner wall and outer wall blending at heel portions of the shoe, and
said sole face having:
a raised rim adjacent said inner wall, and
a raised rim adjacent said outer wall.

17: The horseshoe according to claim 16 wherein a plurality of ridges link said rims such that said raised inner rim, said raised outer rim and said linking ridges in combination form indentations therebetween.

18: The horseshoe according to claim 17 wherein said linking ridges are aligned substantially transverse to said rims where the ridges meet the rims.

19: The horseshoe according to claim 18 wherein said indentations appear approximately rectangular or trapezoidal when viewed perpendicular to said sole face.

20: The horseshoe according to claim 16 wherein each said shock absorbing elastomeric material is a polyurethane.

21: The horseshoe according to claim 20 wherein each said shock absorbing elastomeric material is a thermoplastic urethane bonded to said rigid material in an injection molding process.

22: The horseshoe according to claim 20 wherein said first layer and said second layer are made of the same elastomeric material.

23: The horseshoe according to claim 16 wherein the core is formed of an aluminium aluminum based alloy.

24: The horseshoe according to claim 16 wherein a hard insert is anchored into said layer of rigid material and protrudes into one of said first and second layers to provide a wear resistant strip.
